(19) United States
(12) Patent Application Publication
(10) Pub. No.: US 2004/0040581 A1
(43) Pub. Date: Mar. 4, 2004

(54) Method of and apparatus for controlling the operation of a suction-type pool cleaner

(75) Inventor: Frederick Johannes Bruwer, Paarl (ZA)

Correspondence Address: William A. Blake, Jones, Tullar & Cooper, P.C., Eads Station, P.O. Box 2266, Arlington, VA, 22202, US

(73) Assignee: Azoteq (Pty) Ltd

(21) Appl. No.: 10/649,818

(22) Filed: Aug. 28, 2003

Related U.S. Application Data
(63) Continuation of application No. PCT/ZA02/00022, filed on Feb. 27, 2002.

(30) Foreign Application Priority Data
Feb. 28, 2001 (ZA) ZA 2001/1650

(51) Int. Cl. B08B 7/04

(52) U.S. Cl. 134/18; 134/21; 15/319; 15/340.1; 15/409

(57) ABSTRACT

Apparatus for controlling a suction-type pool cleaner, which is not connected to an external power supply by electrical conductors, employs an electrical generator powered by water flow through the cleaner. The output of the generator is used, under the control of a computer, optionally in response to sensors, to actuate a motor or a valve to influence the movement path of the cleaner through the water.

### CROSS REFERENCE TO RELATED APPLICATIONS

This application is a continuation, under 35 U.S.C. § 120 and 365(c), of International Application No. PCT/ZA02/00022, which was filed on Feb. 27, 2002 and designates the US.

### BACKGROUND OF THE INVENTION

This invention relates generally to the cleaning of swimming pools and more particularly is concerned with controlling the operation of a suction-type pool cleaner which is not connected to an external power source by means of electrical leads.

As used herein “suction-type pool cleaner” includes a device which moves over a submerged surface in a swimming pool and which is connected to a suction inlet, leading to a filtration unit associated with a swimming pool, through the medium of a flexible suction hose.

Suction-type pool cleaners are known in the art. Ideally this type of cleaner should move in a substantially random manner over a submerged swimming pool surface which is to be cleaned. This ensures that the entire submerged surface is cleaned. This ideal is however rarely met in practice in that the movement of the cleaner is subject to external factors such as the geometry of the pool and of the pool surface, the effect of steps and corners inside the swimming pool, the strength of water flow through the cleaner, the amount of dirt in the water, the capability of the cleaner to “climb” the sides of the swimming pool and draw air into the filtration system, and the like. As a consequence of these factors many pools cannot be adequately cleaned by means of a suction-type cleaner.

Electrically driven pool cleaners on the other hand may provide a more comprehensive cleaning activity but are more expensive to purchase and may require facilities which are not normally available at a swimming pool, for example electrical supply connections suitable and safe for use in such environments.

### SUMMARY OF THE INVENTION

The invention provides a method of operating a suction-type pool cleaner which is not connected via electrical leads to an external power source which includes the step of electrically controlling at least one operating characteristic of the cleaner.

According to one form of the invention the control step is carried out in response to at least one sensed input.

The suction-type pool cleaner may be caused to move by water flow through the cleaner e.g. as in cleaners of the type sold under the name KREEPY KRAULY or BARACUDA.

As used herein “operating characteristics” and “sensed input” include decision making functions, control parameters and input data of, or associated with, the cleaner. Such characteristics and inputs may for example include one or more of: water flow rate through the cleaner; its direction of movement; its speed of movement; its travel path through the water, the condition of the pool floor (submerged surface); the presence of dirt; leaves or other debris; and, the physical structure of the pool, e.g. the presence of steps, corners and other formations, and the like.

The method may include the steps of sensing at least one operating condition of the cleaner, a pool in which the cleaner operates, and a filter system associated with the pool and, in response thereto, of controlling the operating characteristics.

The operating conditions which are sensed may include any one or more of the factors which influence the movement or cleaning action of the cleaner. Such conditions may include; for example, the speed of movement of the cleaner; its direction of movement; its attitude in the water, e.g. horizontal, vertical or inclined; its height in the water above a submerged surface and, in particular, its presence at an air/water interface, i.e. at the surface of the water in the swimming pool; the water flow rate through the cleaner; whether the cleaner is stationary and in operation, or stationary at start-up; and the like. The invention is not limited in this regard.

It also falls within the scope of the invention to store one or more patterns or modes of operating characteristics and to control the operation of the cleaner in accordance with a stored pattern. Thus, according to one aspect of the invention, one or more control characteristics which relate to one or more sets of predetermined parameters pertaining to the cleaner operation are stored and such characteristics are implemented to control the operation of the cleaner, from time to time or continuously.

The cleaner may thus be controlled in response to actual conditions, i.e. on a real time basis or according to stored characteristics, or a combination of both techniques may be employed.

The method may include the step of generating electrical power for controlling the operating characteristics from water flow through the cleaner.

The invention also extends to apparatus for use with a suction-type pool cleaner which is not connected to an external power source by electrical leads which includes electrical energy supply means and control means which is powered by the electrical energy-supply means for controlling at least one operating characteristic of the cleaner.

The apparatus may include means for sensing at least one operating condition of the cleaner and the control means may be responsive to the sensing means, for controlling at least one operating characteristic of the cleaner.

The apparatus may include storage means and the control means may be responsive to data or information stored in the storage means, for controlling at least one operating characteristic of the cleaner.

The electrical energy supply means may include drive means which is responsive to water flow through the cleaner and electrical energy generating means, which is powered by the drive means, for producing a supply voltage which is applied to the electrical energy supply means.

The supply voltage may be regulated or shaped according to requirement to ensure a satisfactory supply voltage for powering the control means.

The apparatus may include a storage device such as a capacitor, battery or any other suitable device, which can be used to supply or build up energy so as to perform, from time to time, tasks requiring high energy usage, e.g. to operate a valve, motor or similar device.

The operating condition or conditions which are sensed by the sensing means may vary according to requirement and for example may include one or more of the following: movement of the cleaner; its direction of movement; its speed of movement; its attitude in the water, e.g. horizontal, vertical or inclined; water flow rate through the cleaner; and the like.

In response to the sensing means, the control means may control one or more operating characteristics of the cleaner selected from the following: water flow rate through the cleaner; its direction or speed of movement, its attitude in the water body; and the strength of a suction type force applied to the cleaner.

To control water flow rate through the cleaner use may be made of a valve, a throttle, a diverter or the like which regulates water flow rate through the cleaner.

To vary the direction of movement of the cleaner, at least one suction inlet may be opened or closed to a required extent, to impart thrust to the cleaner in a desired direction in order to change its direction of movement, or to create friction which causes a change in the cleaner's direction of movement.

The storage means may include memory means for storing a plurality of parameters relating to pool cleaner movement and such parameters may be employed, in response to the operating conditions of the pool cleaner or on any other predetermined basis, to influence the movement or operating characteristics of the cleaner.

By using one or more valves which are controlled by the control means, or by controlling the movement of wheels which are used to move the pool cleaner over a submerged surface (depending on the type of pool cleaner used), the control means may be used to prevent the pool cleaner from getting stuck in a pool or for increasing the degree of random movement of the pool cleaner.

The control means may be used for causing the pool cleaner to follow a defined route through the pool or to detect dirt in order to move away from surfaces in the pool which are already clean. This may be achieved by fitting sensors of any appropriate type to the cleaner and by causing operation of the control means which is responsive to the sensors. The sensors may be light sensitive, or detect contrasting colors which are indicative of areas to be cleaned or avoided. It is also possible to position one or more markers on the submerged surface which is to be cleaned to cause the pool cleaner to follow such markers, or to be guided by the markers. The markers could be reflective discs, or magnetic strips, which are adhered to the submerged surface at chosen locations. The sensors are designed to detect those markers and, for example, thereupon to cause the cleaner to change direction or proceed in a chosen direction, or take any other appropriate action.

The movement and position of the pool cleaner, relatively to the pool, may be monitored by detecting, wheel movement through the use of suitable indicators such as gears and optical rotation counters.

The invention is preferably based on the following:

(a) generating electrical energy using energy extracted from a flow of water through the cleaner;

(b) using the generated electrical energy to power decision-making electronics which can monitor the movement and action of the pool cleaner and detect data relating to surroundings of the pool cleaner; and

(c) using the data to influence or control at least one of the following: the movement of the pool cleaner, actions of the pool cleaner, and suction through the pool cleaner.

The pool cleaner is then controlled in a way which is dependent on the type of pool cleaner with which the apparatus is used. For example, If the cleaner rides on wheels then a braking pressure may be exerted on one or more wheels to alter the direction of movement of the cleaner. Suction flow to the pool cleaner or from the pool cleaner may also be altered through one or more openings to exert thrust on the cleaner to cause it to move in a desired direction.

The generation of electrical energy may be achieved by making use of any suitable actuator such as a turbine, propeller or water wheel which drives an electrical generator, or use may be made of a paddle, pendulum member or similar device which is moved to and fro, with an oscillatory action, as water flow through the cleaner varies, e.g. of the type used in the KREEPY KRAULY pool cleaner.

The energy which is produced in this way may be transferred to a generator using a mechanical device such as an axle, or by making use of a magnetic coupling.

The apparatus may include one or more input devices for controlling its operation. For example a keypad or similar device may be employed whereby a user may input control information which determines the operation of the apparatus.

It is known that the operation of a suction-type pool cleaner can be influenced by the rate of water flow through the pool cleaner. Conventionally, the water flow rate is throttled to a desired level by making use of a pressure relief valve. In accordance with one aspect of the invention, however, the water flow rate is monitored and use is made of an electrically controlled valve or throttle to adjust the water flow rate to a desired level. In this way the suction strength which is applied to the pool cleaner can be adjusted continuously or automatically to 15 achieve optimal or good results.

A similar technique can be used to relieve the workload on a motor which is driving a pool pump which is used to draw water through the suction-type pool cleaner. For example if the pool cleaner should not move freely, i.e. is stuck at a problem location in a swimming pool, then the lack of movement can be sensed and the pool cleaner can be bypassed so that water flows through one or more alternative openings into a filter system of the pool and not via the pool cleaner into the filter system, until the pool cleaner is freed, either through its own actions or due to external factors.

### BRIEF DESCRIPTION OF THE DRAWINGS

The invention is further described by way of examples with reference to the accompanying drawings in which:

FIG. 1 illustrates apparatus according to the invention used with a conventional suction type pool cleaner;

FIG. 2 is similar to FIG. 1 but illustrating a different suction-type pool cleaner;

FIGS. 3 and 4 correspond essentially to FIGS. 1 and 2 respectively but illustrate more compact arrangements;

FIG. 5 is a schematic representation of apparatus according to the invention;

FIG. 6 illustrates a variation of the apparatus of the invention;

FIG. 7 schematically illustrates a water wheel for powering the apparatus of the invention;

FIG. 8 is a block diagram of an electrical circuit incorporated in the apparatus of the invention; and

FIG. 9 depicts a sensing switch for use with the apparatus of the invention.

### DETAILED DESCRIPTION OF THE PREFERRED EMBODIMENTS

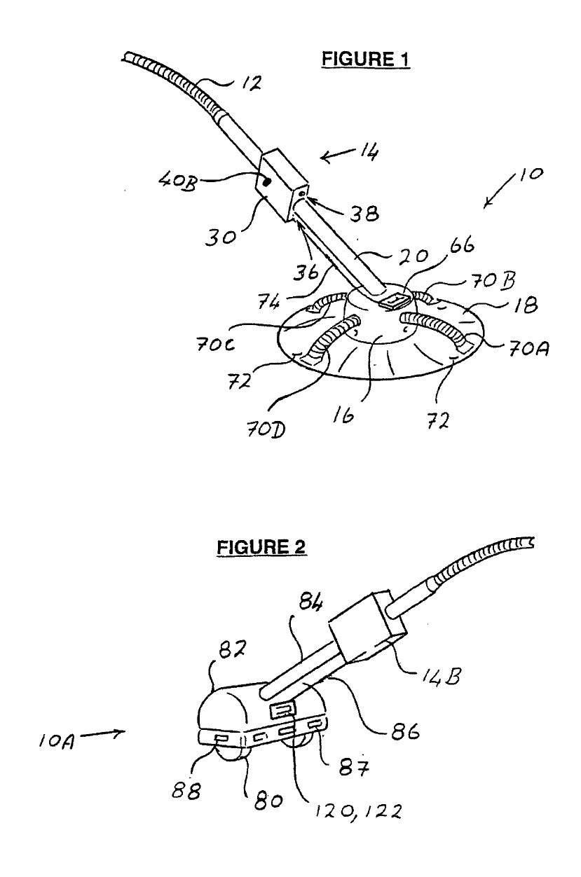

FIG. 1 of the accompanying drawings illustrates a conventional pool cleaner 10 of the suction type which is connected by means of a flexible suction hose 12 to a suction inlet in a weir or similar point in a pool filtration system, not shown, and apparatus 14 according to the invention which is connected in-line with water flow through the cleaner 10.

The cleaner 10 is known in the art and its construction is therefore not described herein save to the extent that a knowledge of the pool cleaner construction may be required for an understanding of the operation of the apparatus 14. For example, the cleaner may be of the kind sold under the name KREEPY KRAULY or BARACUDA. It is to be noted that the invention applies to cleaners which are not connected to an external power source by means of electrical leads or conductors.

The cleaner 10 includes a body 16 to which is attached a submerged surface engaging flexible disk or foot 18. A pipe 20 leads from the body and the apparatus 14 is attached to the pipe. Water flow through the body is channeled by the pipe 20 to the flexible suction pipe 12. The pipe 20 is normally fixed to the body 16 and is rigid but may vary materially in length depending on the type of cleaner.

In use of the cleaner 10, water flow through the body to the flexible pipe 12 causes movement of an actuator or valve mechanism in the body, in a known way, with the result that the water flow through the flexible pipe 12 is altered or varied in a manner which causes movement of the pool cleaner 10 over a submerged surface. Dirt on the surface is entrained in water which is drawn through the body and is directed to a filter system. As has been indicated these aspects are known in the art.

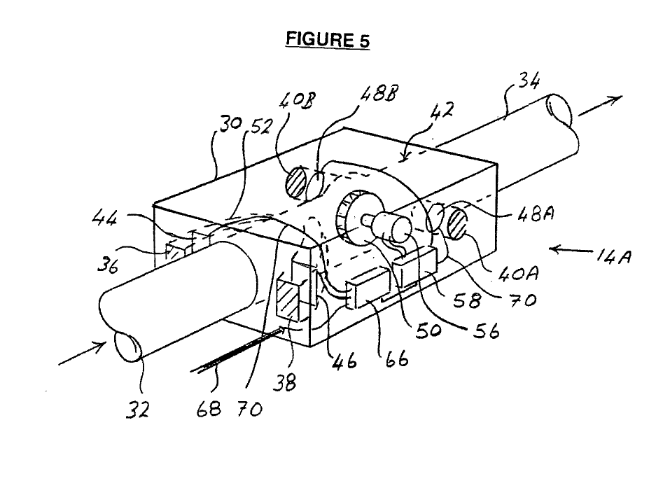

The apparatus 14 may take on various forms and FIG. 5 illustrates one embodiment of the apparatus, designated 14A. The apparatus 14A includes a housing 30 to which are connected an inlet and an outlet spigot 32 and 34 respectively. The pipe 20 is connected to the spigot 32 and the spigot 34 is connected directly or indirectly to the flexible suction hose 12.

The housing has, in this example, two inlets 36 and 38 on one side of the housing and inlets 40A and 40B, respectively, on opposed sides of the housing which lead through respective conduits to a flow passage 42 extending between the spigots 32 and 34. Valve mechanisms 44, 46 and 48A and 48B respectively, which are shown somewhat symbolically, are mounted in the respective conduits.

A turbine or water wheel 50 is mounted in the flow passage 42 downstream of conduits 52 and 54 respectively which lead from the inlets 36 and 38. The turbine drives an electrical generator 56 which produces an electrical voltage which is fed to a power supply unit 58. Ideally the turbine should be exposed to the full water flow through the suction pipe, i.e. it should be downstream of any inlets to the suction pipe or the flow passage 42 so that its capacity to generate electrical energy is increased.

The unit 58 powers an electronic control unit 66, which is described in detail hereinafter. Wires 68 from the power supply and one or more sensors, not shown, lead to the control unit and provide information on operating parameters of the pool cleaner or the environment in which it operates. Control leads 70 extend from the control unit to the valves 44, 46, 48A and 48B.

Referring again to FIG. 1, it is evident that when water flows through the body 16 of the pool cleaner 10, it also flows through the passage 42 in the housing 30 and then to the filtration section of the swimming pool installation. The water flow drives the turbine 50 and the mechanical energy which is thereby produced drives the generator 56. The electrical energy, as indicated, powers the control unit 66. This enables the control unit 66, using information input via the wires 68 from respective sensors, to take decisions regarding the operation of the cleaner according to predetermined requirements.

The sensors may vary according to operating conditions, practical conditions and installation parameters, but typically include one or more of the following: devices which can determine the movement of the cleaner, its speed of movement, its direction of movement, its attitude or orientation in the water, the period for which the cleaner has been in motion and the like. Depending on the input information, the control unit can partially or totally close one or more of the inlets 36, 38, 40A and 40B by operating the respective valves 44, 46, 48A and 48B.

When the valves 44 and 46 are opened, wholly or partially, water flow through the body of the cleaner is diminished. This technique can be used for optimizing the flow rate through the cleaner and allows the normal pressure relief valve, which is mechanically or hydraulically actuated and which is usually associated with a cleaner, to be dispensed with. It is to be noted that the rate at which the turbine 50 moves is, itself, a reflection or measurement of the water flow rate and this can be used to provide information to the control unit to allow the water flow rate to be controlled.

The inlets 40A and 40B are on opposing sides of the housing 30. If water is allowed to flow through one of these inlets, then a reaction force is generated on the housing which tends to displace the rigid pipe 20 to one side and in this way, the direction of movement of the cleaner is gradually altered. The valves 48A and 48B can be controlled in response to operating conditions, or on a time or other basis, to ensure 10 that the degree of random movement of the cleaner is varied. The arrangement can be such that the cleaner can be caused to move using the same fundamental principle which drives the cleaner with its normal motion.

FIG. 1 also illustrates flexible conduits 70A to 70D respectively which extend from the disk 18 to the body 16 of the cleaner. These conduits are provided in addition to conventional suction holes 72 in the disk. Water flow through these conduits can be controlled in a manner similar to what has been previously described in that each conduit can have a respective valve (similar for example to the valve 44) connected to it. Control wires 74 extend from the apparatus 14 to the valves and allow the valves to be opened or closed individually, according to requirement. This allows a further steering action to be exerted on the pool cleaner for uneven suction forces, exerted through the medium of the disk 18, cause the path of movement of the cleaner to be varied.

FIG. 2 illustrates a cleaner 10A which is driven in a known manner by making use of an internal turbine or water wheel which imparts direct mechanical movement to wheels 80 which protrude from an underside of a body 82 of the cleaner. The wheels 80 engage a submerged surface and, when rotated, cause the body to move over the submerged surface. Apparatus 14B, which is essentially the same as the apparatus 14A described in connection with FIGS. 1 and 5, is connected to a rigid pipe 84 which extends from the body 82. The water flow rate through the apparatus 14B is controlled, and directional water jets into the housing of the apparatus 14B are used, in a manner similar to what has been described hereinbefore, to optimize the operation of the cleaner 10A and to change its direction of movement. A control wire 86 from the apparatus, instead of controlling valves in suction conduits 70, as is the case in FIG. 1, is used to control water flow through respective inlets 87 mounted at strategic positions on the body 82. It is also possible, using electrically actuated brakes 88, associated with the respective wheels 80, to inhibit or stop rotation of a chosen wheel in order to change the direction of movement of the pool cleaner.

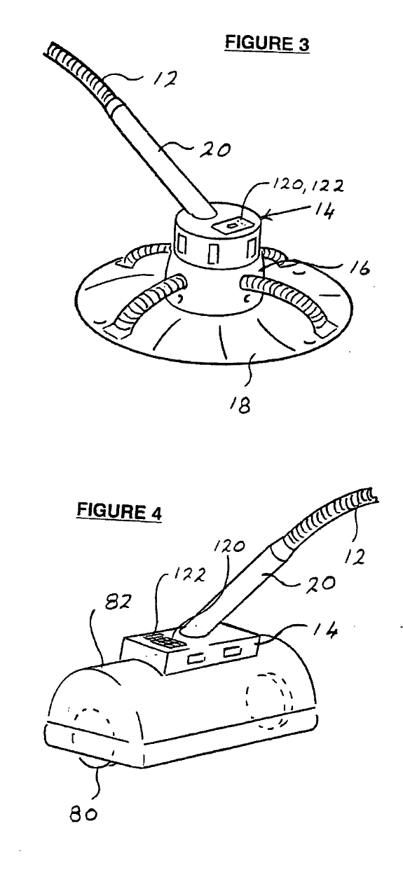

In the embodiments shown in FIGS. 1 and 2, the apparatus 14 or 14B is mounted on a pipe which extends from a body of the pool cleaner and is positioned some distance from the body. FIGS. 3 and 4 correspond respectively to FIGS. 1 and 2 but show that the apparatus may be mounted more or less directly on the body 16 or 82 to provide a more compact arrangement. The functions of the apparatus and of the resulting combinations are essentially the same as what has been described herein before.

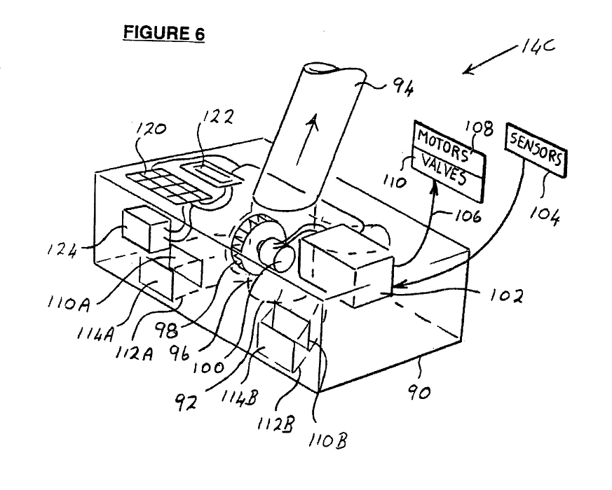

FIG. 6 illustrates a variation of the apparatus of the invention, designated 14C. The apparatus includes a housing 90 with an inlet 92 and an outlet spigot 94. A flow passage 96 extends between the inlet and the outlet and a turbine or water wheel 98 is mounted in the passage. The turbine drives a generator 100 which generates an electrical voltage which is applied to a power supply and control unit 102. Sensors 104 which are responsive to any desired operating parameters of the cleaner or the environment in which it functions provide information to the unit 102.

The control unit 102 produces control information taking into account various factors and this information is output via wires 106 to motors 108 or control valves 110, depending on the type of control function which must be exerted. The valves 110 are shown schematically as units 110A and 110B in flow passages 112A and 112B, respectively, which extend from inlets 114A and 114B in a side wall of the housing 90. By judicious operation of the valves 110A and 110B, directional forces can be imparted to the housing 90 to control its direction of movement and hence alter the direction of movement of a cleaner with which the apparatus 14C is associated. Similarly, these valves can be used to regulate the suction force.

The apparatus 14C includes a keyboard 120 or any equivalent input device by means of which control signals can be input to the control unit 102. A display 122 is provided for a user to ascertain information which is being input, the control function or mode of the unit 102, or any other appropriate information. An additional control function or interface with the unit 102 can be provided by means of an electronic assembly 124 which may include a memory of stored routines. For example, it is possible to store in the memory a plurality of sequences of operations which can be carried out by the unit 102, according to requirement, as selected by a user inputting information via the keyboard 120. It is also possible for a user to build up a library of routines, chosen by the user, as being optimal for controlling the function of a cleaner in a particular swimming pool.

As can be seen, by way, of example only, in FIGS. 2 and 4, the body of the pool cleaner can carry the keyboard 120 and the display 122.

In a more simple application, the unit 14 may sit directly on a fixed inlet to the pool filtration system on an opposing side of the flexible pipe. In this embodiment, it may control the suction to the pool cleaner and may visually indicate low suction or suction status.

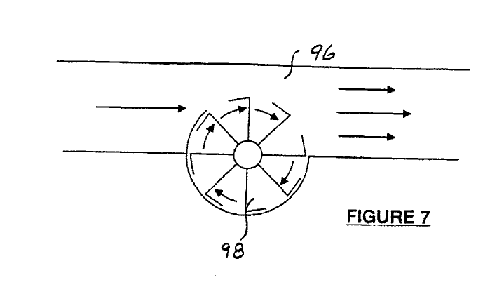

FIG. 7 schematically depicts a turbine or water wheel 98 mounted in a flow passage or path 96, as described hereinbefore. As has been noted, the speed of rotation of the water wheel, particularly if it is not connected to an electrical generator, is an indication of the water flow rate through the passage 96 and this can be used as a control parameter to the control unit 102 or the assembly 124, as required.

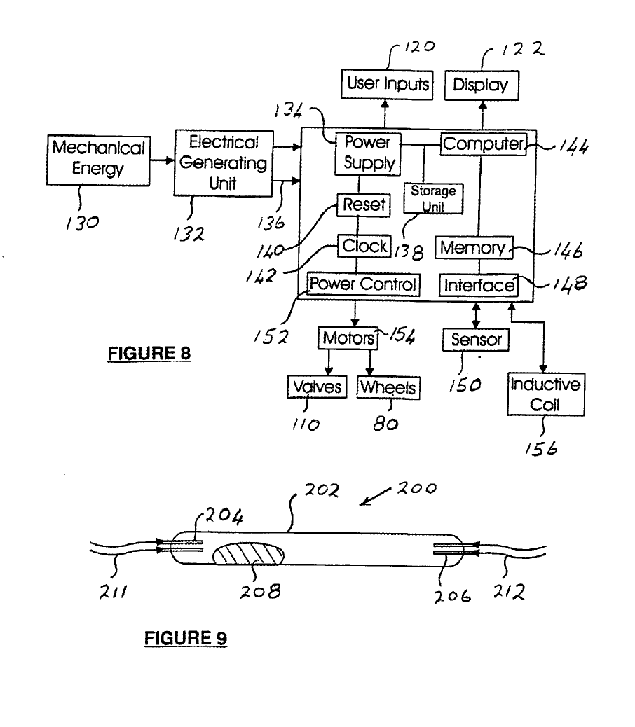

FIG. 8 is a block diagram representation of the apparatus of the invention. Mechanical energy 130, produced by water flow through the pool cleaner, drives a water wheel or turbine, (98, see FIG. 6) and this in turn drives an electrical generator 132. The water wheel may also be in the shape of a sphere or have any other appropriate shape according to requirement. In one embodiment, the generator and water wheel are combined and constitute an armature which is exposed to a magnetic field so that the supply voltage is directly produced. A flywheel or clutch mechanism may be required to convert uneven flow of the turbine into a more even mechanical movement.

The electrical energy produced by the generator 132 is transferred to a power supply unit 134 via wires 136. In the power supply unit 134, the voltage from the generator 132 is converted from AC to DC (if required) and is also regulated to an appropriate operating voltage, for example, of the order of 5V. The power supply 134 must also provide an energy storage facility 138 to enable the electronics to continue functioning if the water flow is interrupted. This facility can also be used to provide high power outputs, when required, e.g. to drive a valve or motor with a greater than normal power consumption. This may conveniently be done by means of a backup capacitor or a small onboard rechargeable battery. It is also necessary to smooth out peaks in energy requirements, for example, when the motors 108 or valves 110 are operated.

A reset unit 140 provides for smooth power backup and power down situations when the water flow starts, gets interrupted or stops. A clock/oscillator 142 provides timing to a microprocessor or microcontroller 144. The control apparatus has a memory unit 146 which may be external and in which are stored predetermined routines or operating parameters, and RAM and read/write non volatile memory (EEPROM or flash).

The non-volatile memory is used, for example, to store parameters selected by a user, or pool data. The memory may also be used for storing reference values relating to suction strength. For example, if the water flow rate through the pool cleaner drops below a desired value, then a warning may be given to the user on the display unit 122 (see FIG. 6).

An interface unit 148 converts analogue signals to and from sensors 150, which may vary according to requirement. As has been noted, it is possible for example to cause the cleaner to follow markers, e.g. light reflective discs or magnetic strips which are fixed to the submerged surface of the swimming pool. These markers are detected by the sensors 150 to cause the cleaner to follow a predetermined path. The sensors 150 may also detect the presence of dirt on the submerged surface and then divert the cleaner to the dirty area so that it functions more effectively. The sensors may be, light sensitive devices which respond to different or contrasting colors in the pool which indicate, for example, the presence or absence of dirt, or magnetic sensors, as the case may be.

A power electronic unit 152 drives motors 154 which are associated with valves 110 (see FIG. 6) or wheels 80 on a cleaner (see FIG. 2).

An inductive coil 156 is provided as a contactless communication interface between the processor 144 and the outside world. Since this may happen when the pool cleaner is out, the water power should be supplied via this interface.

FIG. 9 illustrates a switch 200 to assist with determining the attitude of the pool cleaner body during use. The switch 200 includes a sealed tube 202 with two pairs of contacts 204 and 206, respectively, which protrude into the tube. A mercury blob 208, inside the tube 202, is freely movable according to the orientation of the tube. When the tube 202 is turned so that the contacts 204 are uppermost, the mercury blob 204 bridges the contacts 206, and vice versa. The contacts are monitored by means of wires 210 and 212, respectively, and the information produced by the movement of the mercury blob is input via the interface unit 148 and used by the processor 144 to control movement of the cleaner.

An interface unit 148 converts analogue signals to and from sensors 150, which may vary according to requirement. As has been noted, it is possible for example to cause the cleaner to follow markers, e.g. light reflective discs or magnetic strips which are fixed to the submerged surface of the swimming pool. These markers are detected by the sensors 150 to cause the cleaner to follow a predetermined path. The sensors 150 may also detect the presence of dirt on the submerged surface and then divert the cleaner to the dirty area so that it functions more effectively. The sensors may be, light sensitive devices which respond to different or contrasting colors in the pool which indicate, for example, the presence or absence of dirt, or magnetic sensors, as the case may be.

A power electronic unit 152 drives motors 154 which are associated with valves 110 (see FIG. 6) or wheels 80 on a cleaner (see FIG. 2).

An inductive coil 156 is provided as a contactless communication interface between the processor 144 and the outside world. Since this may happen when the pool cleaner is out, the water power should be supplied via this interface.

FIG. 9 illustrates a switch 200 to assist with determining the attitude of the pool cleaner body during use. The switch 200 includes a sealed tube 202 with two pairs of contacts 204 and 206, respectively, which protrude into the tube. A mercury blob 208, inside the tube 202, is freely movable according to the orientation of the tube. When the tube 202 is turned so that the contacts 204 are uppermost, the mercury blob 204 bridges the contacts 206, and vice versa. The contacts are monitored by means of wires 210 and 212, respectively, and the information produced by the movement of the mercury blob is input via the interface unit 148 and used by the processor 144 to control movement of the cleaner.

What is claimed is:

1. A method of operating a suction-type pool cleaner which is not connected to an external power source by means of electrical leads, said method including the steps of generating electrical energy by water flowing through the pool cleaner; and electrically controlling at least one operating characteristic of the cleaner.

2. A method according to claim 1 wherein the control step is carried out in response to at least one sensed input.

3. A method according to claim 2 wherein the sensed input is selected at least from the group including the condition of a floor or other submerged surface in a pool in which the cleaner operates; the presence of dirt, leaves and other debris; and the physical structure of a pool in which the cleaner operates.

4. A method according to claim 2 wherein the sensed input relates to at least one operating condition of the cleaner, a pool in which the cleaner operates, or a filter system associated with the pool.

5. A method according to claim 4 wherein the operating condition is selected from the group including: the speed of the movement of the cleaner; the direction of movement of the cleaner; the attitude of the cleaner in the water; the height of the cleaner in the water above a submerged surface; the presence of the cleaner at an air/water interface; and, the water flow rate through the cleaner.

6. A method according to claim 1 wherein the operating characteristic is selected at least from the group including: water flow rate through the cleaner, the direction of movement of the cleaner, the speed of movement of the cleaner and the travel path of the cleaner through the water.

7. A method according to claim 1 which includes the steps of storing one or more patterns or modes of operating characteristics and controlling the operation of the cleaner at least in accordance with one of said stored patterns.

8. A method according to claim 1 which includes the step of controlling the cleaner in response to actual operating conditions or according to stored characteristics.

9. A method according to claim 1 wherein the electrical energy is generated using an actuator which drives an electrical generator.

10. A method according to claim 1 which includes the steps of:
(a) using the generated electrical energy to power decision-making electronics which can monitor the movement and action of the pool cleaner and detect data relating to surroundings of the pool cleaner; and
(b) using the data to influence or control at least one of the following: the movement of the pool cleaner; actions of the pool cleaner, and, suction through the pool cleaner.

11. A method according to claim 10 wherein the data used in step (c) is input by a user.

12. A method according to claim 10 wherein, in step (b), the movement of the cleaner is controlled using an electrically controlled valve or throttle to adjust water flow rate through the cleaner.

13. A method according to claim 10 which includes the step, if the cleaner does not move freely, of reducing water flow through the cleaner.

14. Apparatus for use with a suction-type pool cleaner which is not connected to an external power source by means of electrical leads which includes electrical energy supply means, and control means which is powered by the electrical energy supply means for controlling at least one operating characteristic of the cleaner, characterized in that electrical energy is generated by water flowing through the pool cleaner.

15. Apparatus according to claim 14 wherein the electrical energy supply means includes drive means which is responsive to water flow through the cleaner and electrical energy generating means, which is powered by the drive means, for producing a supply voltage which is applied to the electrical energy supply means.

16. Apparatus according to claim 14 which includes means for sensing at least one operating condition of the cleaner and wherein the control means is responsive to the sensing means for controlling at least one operating characteristic of the cleaner.

17. Apparatus according to claim 16 wherein the operating condition or conditions are selected from the group including: movement of the cleaner; the direction of movement of the cleaner; the speed of movement of the cleaner; the attitude of the cleaner in the water; and, the water flow rate through the cleaner.

18. Apparatus according to claim 14 which includes storage means, and wherein the control means is responsive to data or information stored in the storage means, for controlling at least one operating characteristic of the cleaner.

19. Apparatus according to claim 18 wherein the storage means includes memory means for storing a plurality of parameters relating to pool cleaner movement and wherein the parameters are employed to influence the movement operating characteristics of the cleaner.

20. Apparatus according to claim 14 wherein the control means is used to control one or more operating characteristics of the cleaner selected from the group including: water flow rate through the cleaner; the direction or speed of movement of the cleaner; the attitude of the cleaner in the water body; and, the strength of a suction force applied to the cleaner.

21. Apparatus according to claim 14 wherein the control means includes a valve, a throttle or a diverter to regulate water flow through the cleaner.

22. Apparatus according to claim 14 wherein the control means includes at least one suction inlet which is operable to impart thrust to the cleaner in a desired direction in order to change its direction of movement, or to create friction which causes a change in the cleaner's direction of movement.

23. Apparatus according to claim 14 which includes sensors and wherein the control means controls movement of the cleaner in response to the sensors.
